(19) United States
(12) Patent Application Publication
(10) Pub. No.: US 2007/0268362 A1
(43) Pub. Date: Nov. 22, 2007

(54) Compressed data

(76) Inventors: Matthew James West, Corvallis, OR (US); John A. Devos, Corvallis, OR (US); John Apostolopoulos, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/438,238

(22) Filed: May 22, 2006

(51) Int. Cl. H04N 7/14

(52) U.S. Cl. 348/14.15

(57) ABSTRACT

Embodiments of compressing data are disclosed.

### BACKGROUND

Video data maybe digitized and transmitted in compressed form. Transmission of compressed video data may occur via a single, unseparable compressed data stream. However, this all-or-nothing approach to compressed video data transmission does not yield much, if any, flexibility in granularizing the video data for different consumption by different receivers or players.

### BRIEF DESCRIPTION OF THE DRAWINGS

FIG. 1 is a diagram of an embodiment of a system in which each separable substream of a compressed stream of video data is transmitted over a different data channel, according to an embodiment of the present disclosure.

FIG. 2 is a flowchart of an embodiment of a method of video data compression, transmission, and playback as can be achieved within the system of FIG. 1, according to an embodiment of the present disclosure.

FIG. 3 is a diagram of an embodiment of a system in which each separable substream of a compressed stream transmitted over a data channel corresponds to different video data, according to an embodiment of the present disclosure.

FIG. 4 is a flowchart of an embodiment of a method for video data compress, transmission, and playback as can be achieved within the system of FIG. 3, according to an embodiment of the present disclosure.

### DETAILED DESCRIPTION OF THE DRAWINGS

### Transmission of Substreams over Different Data Channels

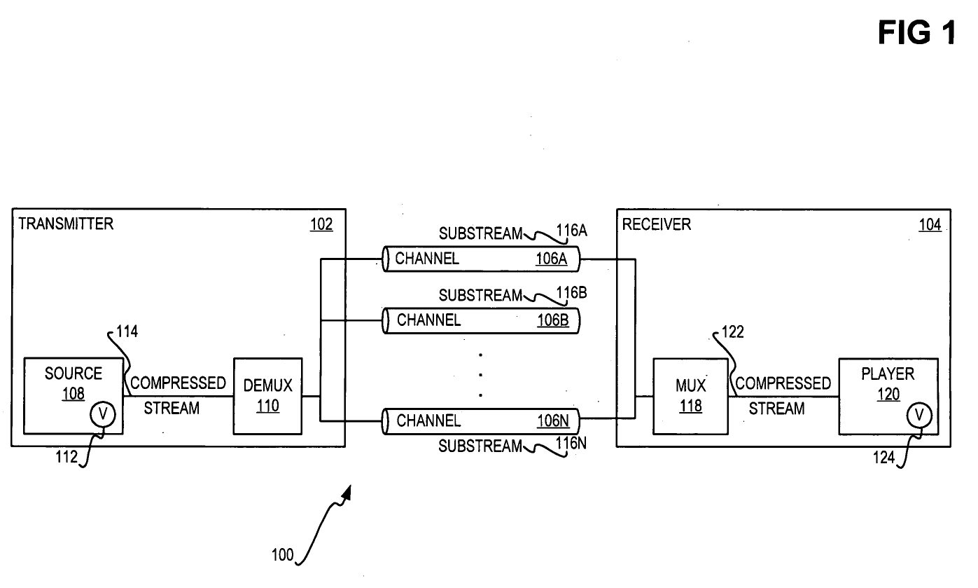

FIG. 1 shows a system 100, according to an embodiment of the present disclosure. The system 100 includes a transmitter 102, a number of different data channels 106A, 106B, . . . , 106N, collectively referred to as the data channels 106, and a receiver 104. The transmitter 102 is depicted in FIG. 1 as including a video data source 108 and a demultiplexer 110, whereas the receiver 104 is depicted in FIG. 1 as including a multiplexer 118 and a video data player 120.

Each of the transmitter 102, the receiver 104, the source 108, the demultiplexer 110, the multiplexer 118, and the player 120 can be or include a computing device, such as a computer, or another type of electronic computing device. Furthermore, whereas in FIG. 1 the transmitter 102 is depicted as including the source 108 and the demultiplexer 110, in another embodiment it may not include either the source 108 and/or the demultiplexer 110. That is, the source 108 and/or the demultiplexer 110 may be separate from, and not part of, the transmitter 102. Similarly, whereas in FIG. 1 the receiver 104 is depicted as including the multiplexer 118 and the player 120, in another embodiment it may not include either the multiplexer 118 and/or the player 120. That is, the multiplexer 118 and/or the player 120 may be separate from, and not part of, the receiver 104.

The video data source 108 compresses video data 112 into a compressed stream 114. In one embodiment, each frame of a number of frames of the video data 112 is compressed on an individual and separate basis. That is, each frame is individually and separately compressed, and thus is independent of the other frames of the video data 112. For instance, the JPEG2000 compression scheme may be employed to individually and separately compress each frame as if each frame were a static image. In this respect, this embodiment of the present disclosure differs from MPEG-2, MPEG-4, and other compression schemes that do not separately and independently compress each frame of video data, but rather use a delta approach, in which a given frame is compressed in relation to changed motion relative to a previous base frame.

Furthermore, the compressed stream 114 into which the video data 112 is compressed includes a number of separable substreams 116A, 116B, . . . , 116N, collectively referred to as the substreams 116. The first substream 116A may include the minimum information used to decompress a semblance of the video data 112. By comparison, the other substreams 116 may be independently decompressable and played back, except that such decompression may make use of the information present in the first substream 116A. As such, such a substream is decompressable so long as the first substream 116A is also received, regardless of whether any of the other substreams have been received. Moreover, the video data 112 can be played back based on the information decompressed from this substream, without information from any other substream, except for that within the first substream 116A. The same compression scheme is employed to generate all the substreams 116 of the compressed stream 114.

It is noted that the video data 112 may include image data, audio data, control data, and other types of data. As such, one or more of the substreams 116 of the compressed stream 114 into which the video data 112 is compressed may include image data, audio data, control data without other types of data, or another type of data. For instance, one of the substreams 116 may include audio data, and another of the substreams 116 may include control data without other types of data.

In addition, or alternatively, the other substreams 116 may be contributively or additively played back, except that such decompression may make use of the information present in the first substream 116A. As such, and as before, such a substream is decompressable so long as the first substream 116A is also received, regardless of whether any of the other substreams have been received. However, the video data 112 is played back based on the information decompressed from this substream, as well as on the information decompressed from one or more other of the substreams 116A, in addition to the information within the first substream 116A. In this sense, the substreams are additive or contributive in their playback. Examples of both independently decompressable substreams and contributively or additively played back substreams are now described.

In particular, each of the substreams 116 other than the first substream 116A may correspond to a different property or portion of the video data 112. With initial respect to the first substream 116A, however, within the JPEG 2000 and other compression schemes, it is common to perform a process referred to as tiling of a frame of the video data 112, in which the frame is divided into a number of non-overlapping regions. The identification of each of these regions, which may be referred to as header blocks, may be provided within the first substream 116A of the compressed stream 114. In such an embodiment, then, this information within the first substream 116A may be used to decompress the properties or portions of the video data 112 as compressed in the other of the substreams 116.

The different properties or portions of the video data 112 as compressed within the substreams 116, except for the first substream 116A, may correspond to different spatial regions of the video data 112. For instance, one of these substreams 116 may correspond to the upper left-hand corner of the video data 112, another may correspond to the upper right-hand corner of the video data 112, and so on. Each of these substreams 116 is separately and independently decompressable in relation to the other of these substreams 116.

For example, so long as the first substream 116A and the substream corresponding to the upper left-hand corner of the video data 112 are received, the upper left-hand corner of the video data 112 may be decompressed from these substreams and played back without having to receive any of the other substreams corresponding to the other spatial regions of the video data 112. Such a substream is independently decompressable, but is not contributively or additively played back, in that playback of the information of the substream does not make use of the information of any other substream except for that within the first substream 112A. Such different spatial regions of the video data 112 being encoded into the different substreams 116 corresponds to different portions of the video data 112—specifically different spatial regions—being compressed within the substreams 116.

The different properties or portions of the video data 112 as compressed within the substreams 116, except for the first substream 116A, may also correspond to different resolutions of the video data 112. For instance, one of the substreams 116 may correspond to a 320×240 resolution of the video data 112, another may correspond to an interlaced 720×480, or 480i, resolution, a third may correspond to a progressive 720×480, or 480p, resolution, a fourth may correspond to a progressive 1280×720, or 720p, resolution and a fifth may correspond to an interlaced 1920×1080, or 1080i, resolution. Each of these substreams 116 is separately and independently decompressable in relation to the other of these substreams 116.

For example, so long as the first substream 116A and the substream corresponding to the 480p resolution of the video data 112 are received, the video data 112 may be decompressed from these substreams and played back at the 480p resolution without having to receive any of the other substreams corresponding to the other resolutions of the video data 112. Such a substream is independently decompressable, but is also not contributively or additively played back, in that playback of the information of the substream does not make use of the information of any other substream except for that within the first substream 112A. Such different resolutions of the video data 112 being encoded into the different substreams 116 corresponds to different properties of the video data 112—specifically different resolutions—being compressed within the substreams 116.

The different properties or portions of the video data 112 as compressed within the substreams 116, except for the first substream 116A, may also correspond to different qualities or distortions of the video data 112. For instance, one of these substreams 116 may correspond to low quality/high distortion of the video data 112, another may correspond to medium quality/medium distortion of the video data 112, and a third may correspond to high quality/low distortion of the video data 112. Each of these substreams 116 is separately and independently decompressable in relation to the other of these substreams 116, but is additively or contributively played back in relation to the lower quality/higher distortion of these substreams 116. For example, to play back the video data 112 at low quality/high distortion, the first substream 116A may be received, as well as the substream corresponding to the low quality/high distortion of the video data 112.

That is, the substreams corresponding to the medium quality/medium distortion and to the high quality/low distortion of the video data 112 do not have to be received. However, to play back the video data 112 at medium quality/medium distortion, the first substream 116A may be received, as well as the substream corresponding to the low quality/high distortion and the substream corresponding to the medium quality/medium distortion of the video data 112. That is, the information present in the substream corresponding to the medium quality/medium distortion is additive or contributive to that within the substream corresponding to the low quality/high distortion, in that the former information refines the latter information to provide for better quality/less distortion.

In this way, a number of the substreams 116 may be received, in addition to the substream 116A, based on the desired playback quality/distortion of the video data 112. If low quality/high distortion is sufficient, then one substream in addition to the first substream 116A may be received without receiving additional substreams. If medium quality/medium distortion is desired, than one additional substream may be received, and if high quality/low distortion is desired, then two additional substreams may be received. Such different quality/distortion of the video data 112 being encoded into the different substreams 116 corresponds to different properties of the video data 112—specifically different quality/distortion—being compressed within the substreams 116.

The different properties or portions of the video data 112 as compressed within the substreams 116, except for the first substream 116A, may correspond to different image components of the video data 112. For instance, one of these substreams 116 may correspond to one color channel, such as luminance, whereas another may correspond to another color channel, such as chrominance. As another example, one of these substreams 116 may correspond to one layer, such as a text layer, whereas another may correspond to another layer, such as a graphics layer. Each of these substreams 116 is separately and independently decompressable in relation to the other of these substreams 116.

For example, so long as the first substream 116A and the substream corresponding to the text layer of the video data 112 are received, the text layer of the video data 112 may be decompressed from these substreams and played back without receiving or using any of the other substreams corresponding to the other layers of the video data 112. Such a substream is independently decompressable, but is technically not contributively or additively played back, in that playback of the information of the substream does not make use of the information of any other substream except for that within the first substream 112A. Such different image components of the video data 112 being encoded into the different substreams 116 corresponds to different portions of the video data 112—such as different color channels or different layers—being compressed within the substreams 116.

The compressed stream 114 of the video data 112 is conveyed from the source 108 to the demultiplexer 110. The demultiplexer 110 divides, or demultiplexes, the individual substreams 116 from the compressed stream 114, and has them transmitted over different of the data channels 106 for receipt by the receiver 104. As depicted in FIG. 1, each of the substreams 116 is transmitted over a corresponding one of the data channels 106. However, in another embodiment, one or more of the substreams 116 may be transmitted over one of the data channels 106, one or more other of the substreams 116 may be transmitted over another of the data channels 106, and so on. That is, each of the data channels 106 carries at least one of the substreams 116, where there are at least two of the data channels 106. The terminology “transmitting the substreams over different data channels” encompasses all of these, as well as other, scenarios.

The data channels 106 can also be referred to as communication or data links, and may be different in one or more ways. For instance, some of the data channels 106 may be wired channels, whereas other of the data channels 106 may be wireless channels. As another example, some of the data channels 106 may be high-bandwidth channels, whereas other of the data channels 106 may be low-bandwidth channels. As a third example, some of the data channels 106 may have guaranteed minimum quality of service (QoS) ratings, whereas other of the data channels 106 may not have any guaranteed QoS ratings.

Thus, as one concrete example, one of the channels 106 may be a low-bandwidth, wired channel having a guaranteed minimum QoS rating. Another of the channels 106 may be a high-bandwidth, wired channel having no guaranteed minimum QoS rating. A third of the channels 106 may be a medium-bandwidth, wireless channel having no guaranteed minimum QoS rating.

The transmitter 102 may transmit different of the substreams 116 of the compressed stream 114 over different of the channels 106 based on the specific properties of these channels 106. For example, it has been described that the first substream 116A may include the minimum information that is used to compress the video data 112 from the compressed stream 114. This minimum information may thus be transmitted over a low-bandwidth, wired channel that has a guaranteed minimum QoS rating. High bandwidth may not be used to communicate this substream, but it may be desirable that this substream, as compared to all other of the substreams 116, is properly transmitted, such that the guaranteed minimum QoS rating of the channel is the appropriate rating for communicating this substream.

As another example, where one of the other substreams 116 corresponds to the relatively low resolution 480i of the video data 112, this substream may be transmitted over a medium-bandwidth, wireless channel that does not have a guaranteed QoS rating. By comparison, where another of the other substreams 116 corresponds to the relatively high resolution 720p of the video data 112, this substream may be transmitted over a high-bandwidth, wired channel that also does not have a guaranteed QoS rating. The high resolution 720p version of the video data 112 may make use of more bandwidth than the low resolution 480i version of the video data 112, hence the decision is made to transmit the substream corresponding to the 720p resolution over the high-bandwidth channel, and the substream corresponding to the 480i resolution over the medium-bandwidth channel. In either case, the lack of a guaranteed QoS rating may be relatively insignificant, since degradation or loss of some of the frames of the video data 112 may be deemed acceptable.

The receiver 104 receives at least the first substream 116A over at least the first data channel 106A. For example, where there are three data channels 106, the receiver 104 may receive the first substream 116A over the first data channel 106A without receiving other substreams. It may also receive the substream 116A over the channel 106A and the second substream 116B over the second data channel 106B without receiving other substreams. The receiver 104 may further receive the first substream 116A over the channel 106A and the third substream 116N over the third data channel 106N without receiving other substreams. It may alternatively receive all the substreams 116 over all the data channels 106.

The multiplexer 118 combines, or multiplexes, the substreams 116 that are received back into a compressed stream 122 of the video data 112. The compressed stream 122 is potentially different than the compressed stream 114, however. Whereas the compressed stream 114 includes all of the substreams 116, the compressed stream 122 may not. Rather, the compressed stream 122 includes those of the substreams 116 that have been received by the receiver 104, or that, for instance, the receiver 104 is authorized to receive, but not other substreams. Stated another way, the compressed stream 112 includes those of the substreams 116 that have been multiplexed into the compressed stream 112 by the multiplexer 118, but not other substreams.

The compressed stream 122 is conveyed from the multiplexer 118 to the player 120. The player 120 decompresses the compressed stream 122 into the video data 124, and plays back the video data 124 based on at least one of the substreams 116 that have been multiplexed into the compressed stream 122. The video data 124 is potentially different than the video data 112. Whereas the video data 112 includes the properties or portions of all the substreams 116, the video data 124 includes the properties or portions of the substreams 116 that have been multiplexed into the compressed stream 122, but not the other substreams.

Playback of the video data 124 is based on at least one of the substreams 116 that have been multiplexed into the compressed stream 122, in that not all of the substreams 116 that have been multiplexed into the compressed stream 122 may be employed. For example, three of the substreams 116 may have been multiplexed into the compressed stream 122: the first substream 116A, a substream corresponding to 480i resolution of the video data 112, and a substream corresponding to 720p resolution of the video data 112. Where the video data 124 is to be played back at a resolution of 480i, the substream corresponding to the 720p resolution of the video data 112 is not employed.

An example is now described in relation to the system 100 as a whole. The video data 112 at the source 108 may be compressed into four different resolutions: 320×240, 480i, 720p, and 1080i. There are thus five substreams 116 within the compressed stream 114: a first substream 116A as has been described, and four substreams corresponding to the four different resolutions. The demultiplexer 110 may demultiplex the compressed stream 114 into these five substreams 116. The first substream 116A and the substream corresponding to the 320×240 resolution may be communicated over the first data channel 106A. Each of the other three substreams 116 may be communicated over their own corresponding data channels.

The receiver 104 may be capable of receiving the first data channel 106A and the data channel corresponding to the 1080i resolution, but not other data channels, and/or may be authorized to receive the first data channel 106A and the data channel corresponding to the 1080i resolution, but not other data channels. As such, the receiver 104 receives the first substream 116A and the substreams corresponding to the 320×240 and the 1080i resolutions, but not other substreams, which are multiplexed by the multiplexer 118 into the compressed stream 122. The player 120 receives this compressed stream 122, and decompresses the video data 124, at the 320×240 and the 1080i resolutions, from the substreams that are contained within the compressed stream 122. The player 120 can then play back the video data 124 at the 320×240 or at the 1080i resolution.

In one embodiment, not particularly depicted in FIG. 1, there may be a feedback path from the receiver 104 back to the transmitter 102. The receiver 104 may provide information to the transmitter 102 as to which of the substreams 116 are being particularly used by the receiver 104, so that the transmitter 102 can adjust the substreams 116 transmitted based on the information provided by the receiver 104. As one example, the receiver 104 may wish to decrease the chrominance within the video data in favor of increased luminance, should bandwidth issues arise.

Furthermore, within the feedback path, the receiver 104 can in one embodiment particularly send the transmitter 102 information regarding what data packets within the stream 122 were received, and which were lost. The transmitter 102 can use this information to determine what portion of the stream 122 to send next. Such a transmitter would use the feedback information to retransmit any lost data packets. However, in one embodiment of the present disclosure, the feedback information can also be used to determine not to send some of the packets of the stream 122 that would otherwise be sent.

For instance, if certain particularly significant packets related to the current frame of the video data 112 are lost during transmission, the transmitter 102 may choose to stop transmitting all the other packets related to the current frame and move onto the next frame for transmission. That is, the current frame is discarded, and instead the transmitter 102 begins transmission of the next frame. This is beneficial in that if the current frame cannot be timely delivered, or with sufficient quality, then discarding the current frame means that the receiver 104 will not display a late or low-quality frame.

The transmitter 102 may also signal to the receiver 104 to discard all packets related to the current frame, instead of the receiver 104 displaying a low-quality frame, where one or more packets of the current are not received by the receiver 104. Similarly, the receiver 104 may make the decision to discard all the packets of the current frame, instead of displaying a low-quality frame. This decision may be based, for instance, on whether the receiver 104 has received a predetermined number of the significant data packets of the frame, or a predetermined subset of the data packets for the frame. The capability for the transmitter 102 or the receiver 104 to discard the current frame and instead focus on the next frame is possible by using the JPEG2000 compression scheme within a video communication system where there is low-delay feedback between the transmitter 102 and the receiver 104.

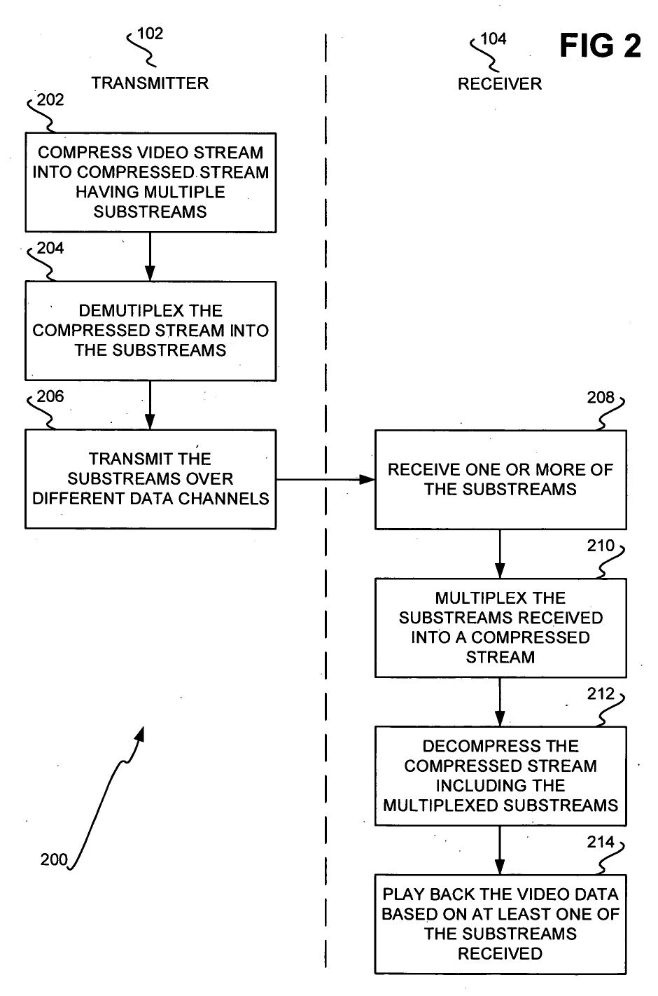

FIG. 2 shows a method 200 that summarizes the video data compression, transmission, and playback that has been described in relation to FIG. 1, according to an embodiment of the present disclosure. The method 200 is divided into two columns. The parts of the method 200 in the left-hand column are performed by or at the transmitter 102 of FIG. 1. By comparison, the parts of the method 200 in the right-hand column are performed by or at the receiver 104 of FIG. 1.

The video data 112 is compressed into a compressed stream 114 that has multiple substreams 116 (202), where each frame of the video data 112 may be compressed on an individual and separate basis. As has been described, the substreams 116 are separable and independently decompressable. The substreams 116 include a first substream 116A having the minimum information to decompress the video data 112, and one or more other substreams that each correspond to a different property or portion of the video data. The compressed stream 114 can be demultiplexed into its constituent substreams 116 (204), and then the substreams 116 are transmitted over different data channels 106 (206), as has been described.

One or more of the substreams 116 are thus received (208), and can be multiplexed into another compressed stream 122 (210). Not all of the substreams 116 transmitted over the data channels 106 may be received. The compressed stream 122, including the substreams 116 that have indeed been received, is decompressed into video data 124 (212), such that it can be said that the substreams 116 that have been received are decompressed. The video data 124 is finally played back in accordance with the properties or portions thereof based on at least one of the substreams 116 that have been received and decompressed (214).

### Transmission of Different Video Data within Same Compressed Stream

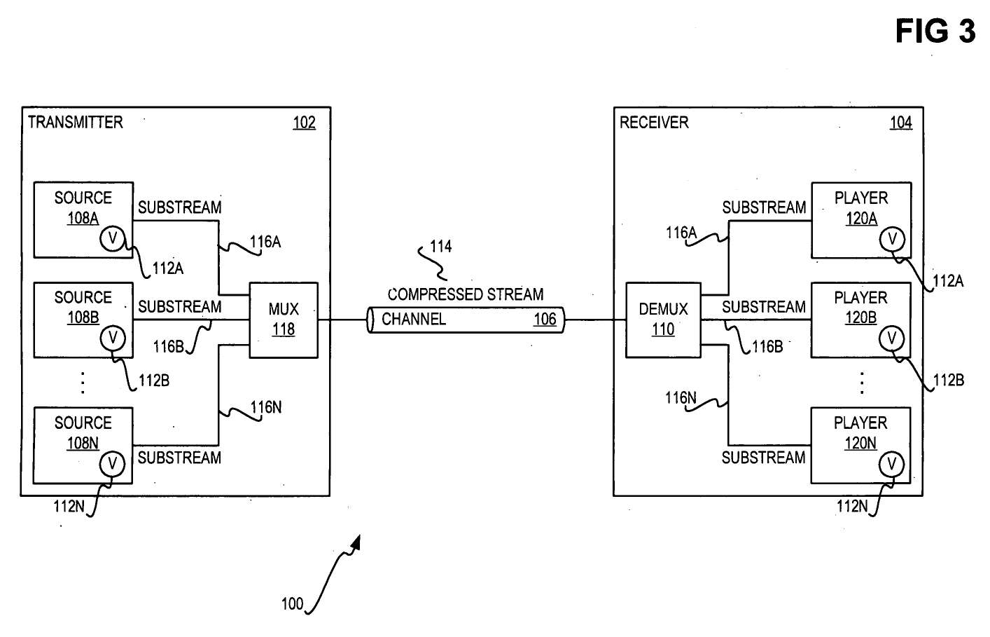

FIG. 3 shows the system 100, according to another embodiment of the present disclosure. The system 100 of FIG. 3 includes the transmitter 102, a single data channel 106, and the receiver 104. The transmitter 102 is depicted in FIG. 3 as including a number of video data sources 108A, 108B, . . . , 108N, collectively referred to as the video data sources 108, and the multiplexer 118. The receiver 104 is depicted in FIG. 3 as including the demultiplexer 110, and a number of video data players 120A, 120B, . . . , 120N, collectively referred to as the video data players 120.

Each of the transmitter 102, the receiver 104, the sources 108, the multiplexer 118, the demultiplexer 110, and the players 120 can be or include a computing device, such as a computer, or another type of electronic computing device. Furthermore, whereas in FIG. 3 the transmitter 102 is depicted as including the sources 108 and the multiplexer 118, in another embodiment it may not include either the sources 108 and/or the multiplexer 118. That is, the sources 108 and/or the multiplexer 118 may be separate from, and not part of, the transmitter 102. In another embodiment, the multiplexer 118 may not be present within the system 100 of FIG. 3.

In addition, whereas in FIG. 3 the receiver 104 is depicted as including the demultiplexer 110 and the players 120, in another embodiment it may not include either the demultiplexer 110 and/or the players 120. That is, the demultiplexer 110 and/or the players 120 may be separate from, and not part of, the receiver 104. In another embodiment, the demultiplexer 110 may not be present within the system 100 of FIG. 3.

The video data sources 108 compress different video data 112A, 112B, . . . , 112N, collectively referred to as the video data 112, into corresponding separable and independently decompressable substreams 116A, 116B, . . . , 116N, collectively referred to as the substreams 116. That is, each of the video data sources 108 compresses a different one of the video data 112. Each of the video data 112 is independent of and different from the other of the video data 112. For instance, each of the video data 112 may be a different television show, or other type of video data. The different video data 112 may themselves already be compressed, such that they can be referred to as pre-compressed video data in one embodiment.

In one embodiment, each frame of a number of frames of each of the video data 112 is compressed on an individual and separate basis, as has been described above in relation to FIG. 1. The compression scheme employed in the embodiment of FIG. 3 is also amenable to having different separable and independently decompressable substreams 116 within the same compressed stream 114. One such compression scheme is JPEG2000. The same compression scheme is employed to generate all the substreams 116 of the compressed stream 114.

Thus, the substream 116A corresponds to compression of the video data 112A, the substream 116B corresponds to compression of the video data 112B, and so on. The substreams 116 are separable in that they can be separated from one another, which is indeed implicit and/or inherent from or in the fact that the substreams 116 are individually generated by the sources 108. Furthermore, the substreams 116 are independently decompressable in that each of the substreams 116 can be separately decompressed, without making use of information present in any of the other of the substreams 116.

The individual compressed substreams 116 of the video data 112 are conveyed from the sources 108 to the multiplexer 118. The multiplexer 118 combines, or multiplexes, the individual substreams 116 into a single compressed stream 114. The compressed stream 114 is then transmitted over a single data channel 106. Each of the substreams 116 may have apportioned thereto the same portion of the bandwidth of the data channel 106, or the bandwidth may be allocated to the different substreams 116 based on the amount of information contained in the substreams 116, the significance or priority of the substreams 116, and so on.

Where the multiplexer 118 is not present, each of the sources 108 may individually transmit its own corresponding one of the substreams 116 over the data channel 106, as part of an implicit compressed stream 114. In such an embodiment, the sources 108 may explicitly communicate with one another reduce the likelihood that the bandwidth provided by the data channel 106 is not exceeded and indeed is effectively utilized, via dedicated or other links among the sources 108. Various protocols may be employed to permit the sources 108 to have the opportunity to transmit their substreams 116 over the data channel 106 in this embodiment.

Furthermore, the sources 108 may not communicate with one another explicitly to reduce the likelihood that the bandwidth provided by the data channel 106 is not exceeded, but may instead monitor the transmissions of the other of the sources 108 to reduce the likelihood that this bandwidth is not exceeded, and is indeed effectively utilized. For instance, various backoff strategies may be employed to permit the sources 108 have the opportunity to transmit their substreams 116 over the data channel 106 in this embodiment. Different strategies can thus be utilized to exploit the bandwidth that the data channel 106 provides, where the multiplexer 118 is present or where the multiplexer 118 is not present. Thus, in such an embodiment, each of the sources 108 monitors the transmissions by the other of the sources 108, and modifies its own transmission of its own substream in response.

Thus, the multiple sources 108 in such an embodiment may transmit over a single data channel 106, which is shared among the sources 108. In one particular example, N senders may be transmitting to N receivers over a single data channel 106. Channel resource allocation, such as which source should transmit next and for how long, can be controlled among the multiple sender-receiver pairs in this example through a centralized or distributed coordination algorithm.

However, in one embodiment, the feedback from each receiver to its corresponding sender can be used to intelligently adapt what should be sent to fit the available channel bandwidth. For example, the sender in question may choose to stop transmitting the current frame, and instead move on to transmitting the next frame. Alternatively, the sender may choose to not transmit the next frame, instead skipping this next frame, and move to the following frame. Such types of actions can sustain high-quality displayed frames at the receiver, and are facilitated by employing the JPEG2000 compression scheme in one embodiment of the present disclosure.

The N senders in this example may also monitor the feedback from all of the N receivers. Therefore, each sender may adapt its processing to fairly share the available bandwidth among the various sender-receiver pairs. Alternatively, each sender may adapt its processing to provide priority for certain sender-receiver pairs over others.

Referring back to the embodiment particularly displayed in FIG. 3, the receiver 104 ultimately receives the compressed stream 114 over the single data channel 106. The demultiplexer 110, where present, demultiplexes the compressed stream 114 into the individual compressed substreams 116, and conveys them to the video data players 120. In the particular example of FIG. 3, each of the players 120 receives a corresponding one of the substreams 116. Thus, the player 120A receives the substream 116A, the player 120B receives the substream 116B, and so on. In another embodiment, however, each of the players 120 may receive one or more of the substreams 116, and each of the substreams 116 may be conveyed to one or more of the players 120.

Where the demultiplexer 110 is not present, the players 120 individually monitor the data channel 106 for those of the substreams 116 of the compressed stream 114 that are of interest, such that the other of the substreams 116 are not stored or are otherwise discarded by the players 120. For example, in such an embodiment, the player 120A may be interested in receiving the substream 116A and not other substreams. Therefore, the portions of the compressed stream 114 relating to the substream 116A, such as the packets of the stream 114 relating to the substream 116A, are retrieved by the player 120A, and the other portions or other packets of the stream 114, relating to the other substreams, are discarded by the player 120A. That is, in this embodiment and in this example, the player 120A receives the substreams 116A . . . 116N comprising the compressed stream 114, but saves the portion thereof relating to the substream 116A without saving the portion relating to the other substreams.

The players 120 decompress the substreams 116 that have been individually received by them into the video data 112A, 112B, . . . , 112N, and play back this video data 112. For instance, as specifically depicted in the example of FIG. 3, the player 120A decompresses the substream 116A into the video data 112A and plays back the video data 112A, the player 120B decompresses the substream 116B into the video data 112B and plays back the video data 112B, and so on. Where a given one of the players 120 receives more than one of the substreams 116, it plays back one of these received substreams 116, in one embodiment without playing back other of the received substreams.

The embodiment of FIG. 3 thus allows a single data channel 106 to be employed to communicate multiple video data 112 from the sources 108 to the players 120. This is achieved, as has been described, by having different compressed substreams 116 corresponding to the video data 112 within a single compressed stream 114. So long as all of the substreams 116 are able to fit into the bandwidth provided by the data channel 106, the embodiment of FIG. 3 is effective for transmission of multiple video data 112.

Furthermore, various approaches may be utilized in conjunction with the embodiment of FIG. 3 to better use the bandwidth provided by the data channel 106. For example, one of the video data 112 may include the same static image over a number of the frames of the video data in question. In such instance, the transmitter 102 may transmit a corresponding compressed substream representing this static image once over the data channel 106. In turn, the receiver 104 may receive and store this static image, and generate a corresponding substream sent to one or more of the players 120 in which this static image is repeated for a number of frames. Therefore, the data channel 106 does not have its bandwidth taken up during this number of frames of the video data in question by the same static image. Other approaches can also be used to employ the bandwidth of the data channel 106.

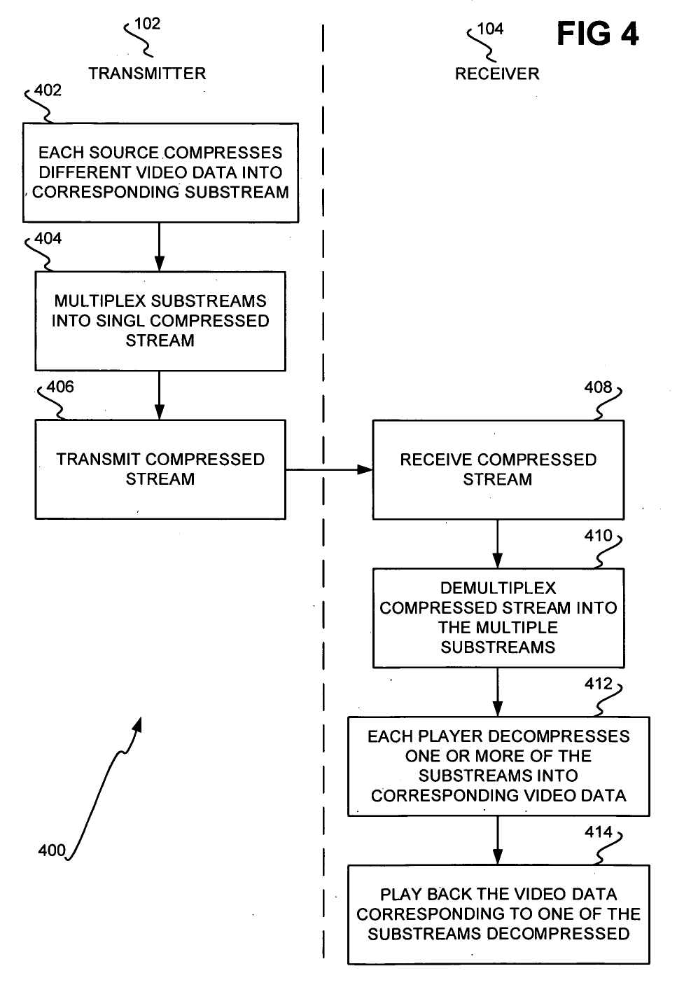

FIG. 4 shows a method 400 that summarizes the video data compression, transmission, and playback that has been described in relation to FIG. 3, according to an embodiment of the present disclosure. The method 400 is divided into two columns. The parts of the method 400 in the left-hand column are performed by or at the transmitter 102 of FIG. 3. By comparison, the parts of the method 400 in the right-hand column are performed by or at the receiver of FIG. 3.

Each of the video data sources 108 compresses a corresponding one or more of the different video data 112 into a corresponding one or more of the compressed substreams 116 (402), where each frame of each of the video data 112 may be compressed on an individual and separate basis. As has been described, the substreams 116 are separable and independently decompressable. The substreams 116 can be multiplexed into a single compressed stream 114 (404), as has been described.

The compressed stream 114 is transmitted over a single data channel 116 (406). In one embodiment, the compressed stream 114 is transmitted as a whole, such as by the transmitter 102, where multiplexing of the individual substreams 116 into the compressed stream 114 has already occurred. In another embodiment, the compressed stream 114 is transmitted via each of its individual substreams 116 being transmitted by a corresponding one of the sources 108, where multiplexing of the individual substreams 116 into the compressed stream 114 is not performed.

The compressed stream 114 is received over the data channel 106 (408), and can be demultiplexed into the multiple individual substreams 116 (410). In one embodiment, the compressed stream 114 is completely received, such as by the receiver 104, where demultiplexing thereafter occurs by the demultiplexer 110 to demultiplex the compressed stream 114 into the individual substreams 116. In this embodiment, each of the players 120 thus receives after demultiplexing one or more of the substreams 116, as conveyed to the player by the demultiplexer 110, and possibly not all substreams 116, as has been described.

In another embodiment, however, each of the players 120 monitors the data channel 106, and therefore each player implicitly receives the substreams 116A . . . 116N comprising the compressed stream 114. In this embodiment, each individual player thus discards the substreams that are not of interest to the player. That is, each of the players 120 discards all the substreams 116 except those that are to be decompressed by the player and potentially played back by the player in question.

Therefore, each of the players 120 decompresses one or more of the substreams 116 into corresponding one or more of the video data 112 (412). In one embodiment, the substreams 116 decompressed by the players 120 are those provided or conveyed by the demultiplexer 110, where demultiplexing occurs. However, where demultiplexing does not occur, the substreams 116 decompressed by the players 120 are those that the players 120 do not individually discard when they each receive the entire compressed stream 114.

Finally, each of the players 120 plays back one or more of the video data 112 corresponding to the one or more of the substreams 116 that have been decompressed by the player in question (414). For instance, if a given player decompresses one substream into one of the different video data, then this is the video data that is played back. If a player decompresses more than one substream into more than one different video data, then one of these different video data may be played back.

### ALTERNATIVE EMBODIMENTS AND CONCLUSION

Two embodiments of the present disclosure have been described. In a first embodiment, the different portions or properties of the same video data are compressed into different substreams of a compressed stream, and the different substreams are communicated over different data channels. In a second embodiment, different video data are compressed into different substreams of a compressed stream, and the compressed stream is communicated over the same data channel.

However, hybrids of the two embodiments are also amenable to that which has been disclosed, and are contemplated herein. As one example, different video data may be compressed into different substreams of a compressed stream, where the different substreams are communicated over different data channels. That is, at least some of the substreams may be transmitted over different data channels as compared to other of the substreams.

Furthermore, whereas in the second embodiment, described in relation to FIGS. 3 and 4, multiple players and multiple sources have been described, in another embodiment there may be one player and/or there may be one source without other players and other sources. Similarly, whereas in the first embodiment, described in relation to FIGS. 1 and 2, a single player and a single source have been described, in another embodiment there may be multiple players and/or there may be multiple sources. In either the first or the second embodiment, the compressed stream may be communicated over a single data link, or over multiple different data links.

We claim:

1. A method comprising:
compressing data into a stream having a plurality of separable substreams, including a first substream having information to decompress the data, and one or more second substreams each corresponding to a different property or portion of the data; and,
transmitting the substreams of the compressed stream over different data channels.

2. The method of claim 1, wherein the data is compressed at and is transmitted by a transmitter, and further comprising, at a receiver:
receiving one or more of the substreams of the compressed stream, including at least the first substream;
decompressing the substreams received; and,
playing back the data in accordance with the properties or portions of the data based on at least one of the substreams of the compressed stream received and decompressed.

3. The method of claim 2, wherein receiving the one or more of the substreams of the compressed stream comprises receiving a sub-plurality of the substreams of the compressed stream, such that not all of the substreams are received.

4. The method of claim 2, wherein the receiver provides feedback to a transmitter and the transmitter adjusts the substreams based on the feedback provided.

5. The method of claim 1, wherein the data comprises video data, and the different property or portion of the data to which each substream corresponds comprises at least one of: a different spatial region of the video data; one or more different image components of the video data; a different resolution of the video data; and, a different quality/distortion of the video data.

6. The method of claim 1, further comprising demultiplexing the compressed stream into the separable substreams.

7. The method of claim 6, further comprising, at a receiver, multiplexing one or more of the substreams received.

8. The method of claim 1, wherein the data comprises video data, and compressing the video data comprises compressing each of a plurality of frames of the video data on an individual and separate basis.

9. The method of claim 1, wherein transmitting the substreams of the compressed stream over the different data channels comprises transmitting the first substream over a data channel having a minimum quality-of-service level.

10. A method comprising:
receiving a compressed stream;
at each of one or more players,
decompressing one or more of substreams from the compressed stream, each substream corresponding to different data; and,
playing back the different data to which each of the substreams that have been decompressed corresponds,
wherein the sources number more than one and/or the players number more than one.

11. The method of claim 10, further comprising, at each of one or more sources:
compressing the different data into a corresponding separable and
independently decompressable substream of the compressed stream; and, transmitting the compressed stream.

12. The method of claim 11, wherein compressing the different data comprises compressing each of a plurality of frames of different video data on an individual and separate basis.

13. The method of claim 11, wherein transmitting the compressed stream comprises each source transmitting the substream to which the different data that have been compressed at the source, as part of the compressed stream.

14. The method of claim 13, wherein each source monitors transmissions by other of the sources and the players and modifies transmission of the substream based thereon.

15. The method of claim 10, further comprising, at a transmitter, multiplexing the substreams to which the different video data was compressed at one or more sources, wherein the transmitter transmits the compressed stream.

16. The method of claim 10, wherein decompressing the one or more substreams comprises decompressing a sub-plurality of the substreams, such that not all of the substreams are decompressed.

17. The method of claim 10, wherein receiving the compressed stream comprises each player receiving the compressed stream and discarding the substreams thereof except for the one or more substreams to be decompressed by the player.

18. The method of claim 10, wherein a receiver receives the compressed stream, and the method further comprises, at the receiver, demultiplexing the substreams from the compressed stream and conveying to each player the one or more substreams to be decompressed by the player.

19. An apparatus comprising:
one or more video player devices, each video player device decompressing one or more of substreams of a compressed stream and playing back the different video data to which each of the substreams that have been decompressed corresponds,
wherein at least some of the substreams are received over different data channels as compared to other of the substreams.

20. The apparatus of claim 19, further comprising one or more video source devices, each video source device compressing different video data into a corresponding separable substream of the compressed stream.

21. The apparatus of claim 20, wherein each video source device is to compress each of a plurality of frames of the different video data on an individual and separate basis.

22. The apparatus of claim 20, wherein each video source device is to transmit the substream into which the different video data has been compressed by the video source device over a corresponding data channel.

23. The apparatus of claim 19, wherein each video player device is to receive all the substreams and is to discard the substreams except for the one or more substreams to be decompressed by the video player device.
